(19) United States
(12) Patent Application Publication
(10) Pub. No.: US 2016/0169033 A1
(43) Pub. Date: Jun. 16, 2016

(54) APPARATUS AND SYSTEM FOR CERAMIC MATRIX COMPOSITE ATTACHMENT

(71) Applicant: General Electric Company, Schenectady, NY (US)

(72) Inventors: Matthew Mark Weaver, Loveland, OH (US); Michael Alan Hile, Cincinnati, OH (US); Kathleen Elizabeth Albers, Park Hills, KY (US)

(21) Appl. No.: 14/569,823

(22) Filed: Dec. 15, 2014

(51) Int. Cl. F01D 25/00; F01D 9/02

(52) U.S. Cl. CPC F01D 25/005; F01D 9/02; F05D 2300/6033

(57) ABSTRACT

An apparatus and system for mechanically connecting components are provided. The apparatus includes a mechanical connecting joint that includes a first joint member formed of a material having a first coefficient of thermal expansion (CTE) value, the first joint member comprising a first sidewall, a second opposite sidewall, and a body extending therebetween. The mechanical connecting joint further includes a second joint member formed of a material having a second CTE value, the second CTE being less than the first CTE. The second joint member includes a first leg facing the first sidewall, a second leg facing the second sidewall, and a connecting member extending between the first leg and the second leg. A first gap is formed between the first joint member and the first leg and a second gap is formed between the first joint member and the second leg.

### STATEMENT REGARDING FEDERALLY SPONSORED RESEARCH & DEVELOPMENT

The U.S. Government has certain rights in this application as provided for by the terms of Contract No. FA8650-09-D-2922.

### BACKGROUND

This description relates to component connection assemblies, and, more particularly, to a component connection assembly that includes materials having different coefficients of thermal expansion (CTE).

At least some known applications of coupling components formed of ceramic matrix composite material (CMC) to components formed of metal in high temperature environments because there typically is a difference in CTE between the two materials. Typically, a clamping load applied to CMC between two pieces of metal will be decreased as the component reaches its high temperature operating condition and the metal grows faster and to a greater degree than the CMC. This loss in clamping load is almost always unacceptable and difficult to overcome in design.

The attachment of load bearing CMC component elements has been attempted with bolted joints that include spring elements to maintain clamping load at elevated temperatures. High CTE materials such as A-286 have been used as spacers to compensate for the low CTE of the CMC. Non-cantilevered nozzles and shrouds have also used pin elements to limited success.

### BRIEF DESCRIPTION

In one embodiment, a mechanical connecting joint includes a first joint member formed of a material having a first coefficient of thermal expansion (CTE) value, the first joint member comprising a first sidewall, a second opposite sidewall, and a body extending therebetween. The mechanical connecting joint further includes a second joint member formed of a material having a second CTE value, the second CTE being less than the first CTE. The second joint member includes a first leg facing the first sidewall, a second leg facing the second sidewall, and a connecting member extending between the first leg and the second leg. A first gap is formed between the first joint member and the first leg and a second gap is formed between the first joint member and the second leg.

In another embodiment, a vane attachment assembly includes a plurality of airfoil vane shanks extending from a vane platform, each of the airfoil shanks comprising a ceramic matrix composite material (CMC) having a first coefficient of thermal expansion (CTE). The airfoil attachment assembly also includes a vane hanger formed of a metal material having a second CTE, the airfoil hanger positioned between adjacent ones of the plurality of airfoil vane shanks, a surface of the airfoil hanger configured to expand outwardly towards the adjacent ones of the plurality of airfoil vane shanks thereby exerting a force into the adjacent ones of the plurality of airfoil vane shanks.

In yet another embodiment, a gas turbine engine assembly includes a rotatable member comprising an axis of rotation and supported within a casing by a plurality of bearings. The gas turbine engine assembly also includes a vane hanger comprising a metal material having a first coefficient of thermal expansion (CTE) positioned radially outward from the rotatable member within the casing, the airfoil hanger comprising a radially outer portion fixedly coupled to the casing and a radially inner portion comprising a vane attachment. The gas turbine engine assembly further includes a vane comprising a radially outer shank portion comprising a first leg and a second leg, each of the first and second legs extending radially outwardly on opposite sides of the airfoil attachment, each of the first and second legs comprising a ceramic matrix composite (CMC) material having a second CTE.

### BRIEF DESCRIPTION OF THE DRAWINGS

FIGS. 1-8 show example embodiments of the method and apparatus described herein.

FIG. 1 is a cross-sectional schematic illustration of an exemplary gas turbine engine assembly having a longitudinal axis.

FIG. 2 is a cross-section of a portion of gas turbine engine assembly shown in FIG. 1 in accordance with an example embodiment of the present disclosure.

FIG. 3 is a radially inwardly looking view of a portion of gas turbine engine assembly shown in FIG. 1 in accordance with an example embodiment of the present disclosure.

FIG. 4 is a radially inwardly looking view of the portion of the gas turbine engine assembly shown in FIG. 1 in accordance with another embodiment of the present disclosure.

FIG. 5 is a side elevation view of a mechanical connecting joint in accordance with an example embodiment of the present disclosure.

FIG. 6 is a plan view of a mechanical connecting joint in accordance with another example embodiment of the present disclosure.

FIG. 7 is a perspective view of a cantilevered solid doublet CMC vane including the vane hanger and shank shown in FIG. 2 and a metal mid seal.

FIG. 8 is a perspective view cantilevered solid doublet CMC vane showing only the CMC parts.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. It is contemplated that the disclosure has general application to analytical and methodical embodiments of joining components having a high CTE with components having a low CTE in industrial, commercial, and residential applications.

Embodiments of the present disclosure describe an attachment configuration for joining two components, for example, a Ceramic Matrix Composite (CMC) vane to a metal airfoil hanger. Although described herein in terms of a cantilevered solid doublet CMC vane, the attachment configuration should be understood to be applicable for any CMC to metal component joint applied to other CMC vanes and structures. As described herein, a metallic hanger is fitted between and pinned to the two CMC vane mounting shanks that extend from the airfoils as continuous plies through the outer end wall. The metallic pins and hanger are fitted with the CMC such that the desired clamping load is achieved as the metal out grows the CMC at operating temperature. The same attachment configuration can be used to mount the metallic inner mid-seal box between vane shanks extending through the inner flow path end wall.

Metallic components being attached to the CMC vane are configured so that they are constrained between or inside the CMC. It therefore uses the difference in coefficient of thermal expansion (CTE) between the CMC and metal to increase the clamping load between the parts at elevated operating temperatures rather than decrease it. For example, in a connection of a cantilevered CMC doublet vane including solid airfoils and integral CMC flow path end walls, a metallic hanger is fitted between and pinned to the two CMC vane mounting shanks. The metallic hanger is fitted between the CMC vane shanks such that the desired clamping load is achieved as the metal out grows the CMC at operating temperature. Likewise, the metallic pin (or shoulder bolt) to CMC hole is sized so that the desired fit is achieved at operating temperature.

The following description refers to the accompanying drawings, in which, in the absence of a contrary representation, the same numbers in different drawings represent similar elements.

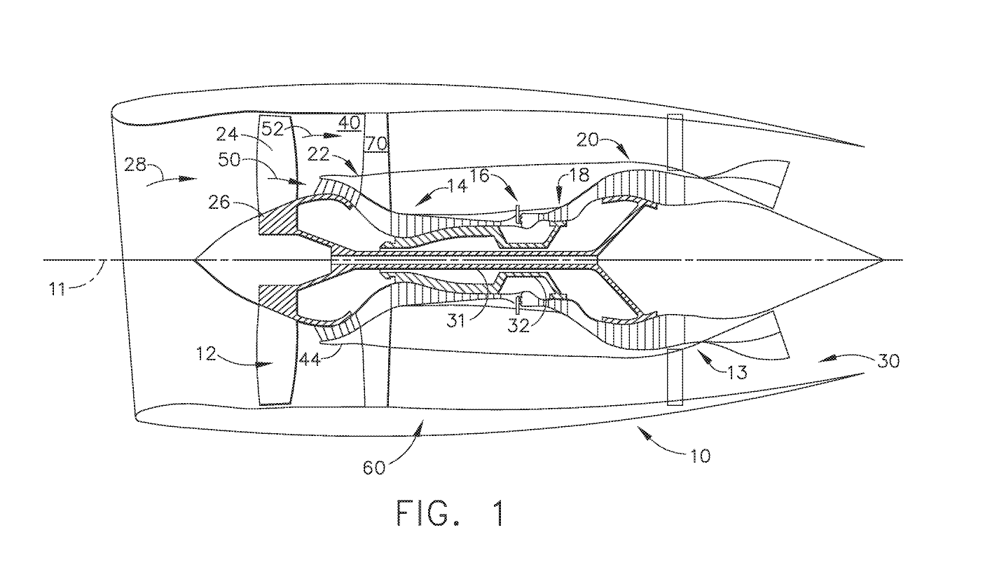

FIG. 1 is a cross-sectional schematic illustration of an exemplary gas turbine engine assembly 10 having a longitudinal axis 11. Gas turbine engine assembly 10 includes a fan assembly 12 and a core gas turbine engine 13. Core gas turbine engine 13 includes a high pressure compressor 14, a combustor 16, and a high pressure turbine 18. In the exemplary embodiment, gas turbine engine assembly 10 also includes a low pressure turbine 20, and a multi-stage booster compressor 22, and a splitter 44 that substantially circumscribes booster 22.

Fan assembly 12 includes an array of fan blades 24 extending radially outward from a rotor disk 26. Gas turbine engine assembly 10 has an intake side 28 and an exhaust side 30. Fan assembly 12, booster 22, and turbine 20 are coupled together by a first rotor shaft 31, and compressor 14 and turbine 18 are coupled together by a second rotor shaft 32. In the exemplary embodiment, engine assembly 10 may be, but is not limited to being, a LEAP or Passport 20 gas turbine engine available from General Electric Company, Cincinnati, Ohio.

In operation, air flows through fan assembly 12 and a first portion 50 of the airflow is channeled through booster 22. The compressed air that is discharged from booster 22 is channeled through compressor 14 wherein the airflow is further compressed and delivered to combustor 16. Hot products of combustion (not shown in FIG. 1) from combustor 16 are utilized to drive turbines 18 and 20, and turbine 20 is utilized to drive fan assembly 12 and booster 22 by way of shaft 31. Gas turbine engine assembly 10 is operable at a range of operating conditions between design operating conditions and off-design operating conditions.

A second portion 52 of the airflow discharged from fan assembly 12 is channeled through a bypass duct 40 to bypass a portion of the airflow from fan assembly 12 around the core gas turbine engine 13. More specifically, bypass duct 40 extends between a fan casing 42 and splitter 44. Accordingly, a first portion 50 of the airflow from fan assembly 12 is channeled through booster 22 and then into compressor 14 as described above and a second portion 52 of the airflow from fan assembly 12 is channeled through bypass duct 40 to provide thrust for an aircraft, for example. Gas turbine engine assembly 10 also includes a fan frame assembly 60 to provide structural support for fan assembly 12 and is also utilized to couple fan assembly 12 to core gas turbine engine 13.

Fan frame assembly 60 includes a plurality of outlet guide vanes 70 that typically extend substantially radially, between a radially-outer mounting flange and a radially-inner mounting flange, and are circumferentially-spaced within bypass duct 40. Guide vanes 70 serve to turn the airflow downstream from rotating blades such as fan blades 24.

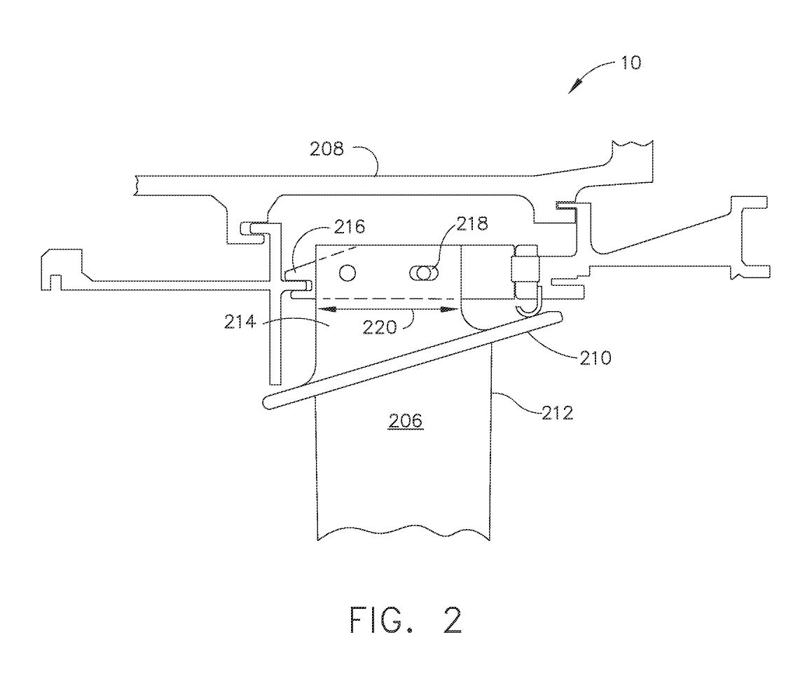

FIG. 2 is a cross-section of a portion of gas turbine engine assembly 10 (shown in FIG. 1) in accordance with an example embodiment of the present disclosure. In the example embodiment, a rotatable member 202 includes a plurality of radially outwardly extending blades 204. Blades 204 are interdigitated with stationary vanes 206 that extend radially inwardly from a casing 208 circumscribing rotatable member 202. Stationary vane 206 includes a platform 210, an airfoil 212 extending radially inwardly from platform 210, and a shank 214 extending radially outwardly from platform 210. Stationary vane 206 is coupled to casing 208 via a metal vane hanger 216. A slot 218 in CMC vane shank 214 allows for differential growth along a length 220 of shank 214.

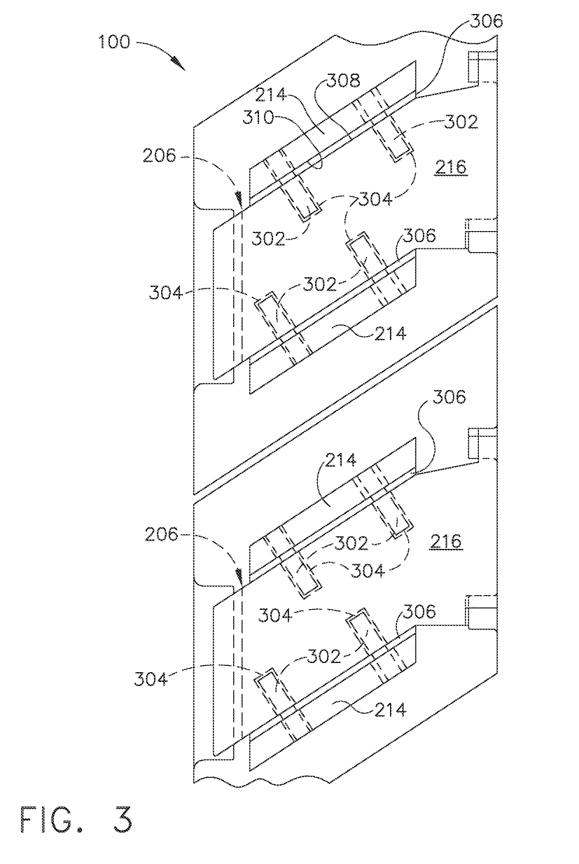

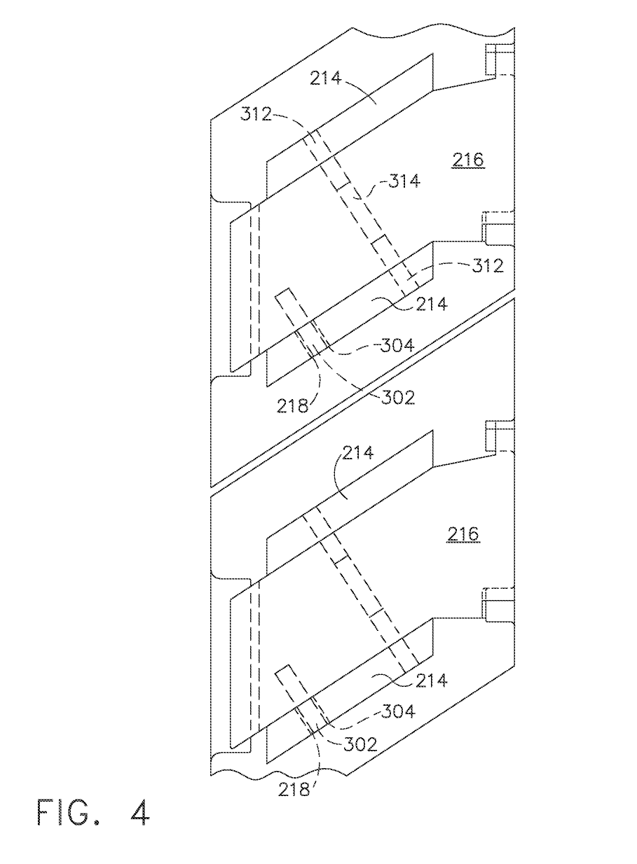

FIG. 3 is a radially inwardly looking view of a portion of gas turbine engine assembly 10 (shown in FIG. 1) in accordance with an example embodiment of the present disclosure. FIG. 4 is a radially inwardly looking view of the portion of gas turbine engine assembly 10 (shown in FIG. 1) in accordance with another embodiment of the present disclosure. In the example embodiment, vane 206 is formed of a ceramic matrix composite (CMC) material having a first coefficient of thermal expansion (CTE). The only part of vane 206 that is visible in FIG. 3 is shank 214. Vane 206 exceeds into the page obscured by vane hanger 216. One or more locating or drift pins 302 extend from within shank 214 into vane hanger 216. Pins 302 may fit loosely into a respective bore 304 in each of shank 214 and may expand at operating temperature to a tight fit within bore 304 of shank 214. In various embodiments, a gap 306 is formed between shank 214 and vane hanger 216. Gap 306 permits easy installation during an assembly process. When gas turbine engine assembly 10 (shown in FIG. 1) heats up during startup, gap 306 is reduced. In one embodiment gap 306 is reduced to approximately zero distance, meaning that a surface 308 of vane hanger 216 bears directly on a surface 310 of shank 214 and/or vane hanger 216. Because vane hanger 216 expands at a different rate than shank 214 because of a difference of CTE of the different materials of which shank 214 and vane hanger 216 are formed, vane hanger 216 expands to take up gap 306, touches shank 214 and applies a force against shank 214. The force is predetermined based on dimensions of shank 214 and vane hanger 216, their respective CTEs, and an expected operating temperature of gas turbine engine assembly 10 (shown in FIG. 1). In another embodiment, three pins are used instead of four pins 302 as shown in FIG. 3. A pair of pins 312 may share a through bore 314 that extends through shank 214 and vane hanger 216.

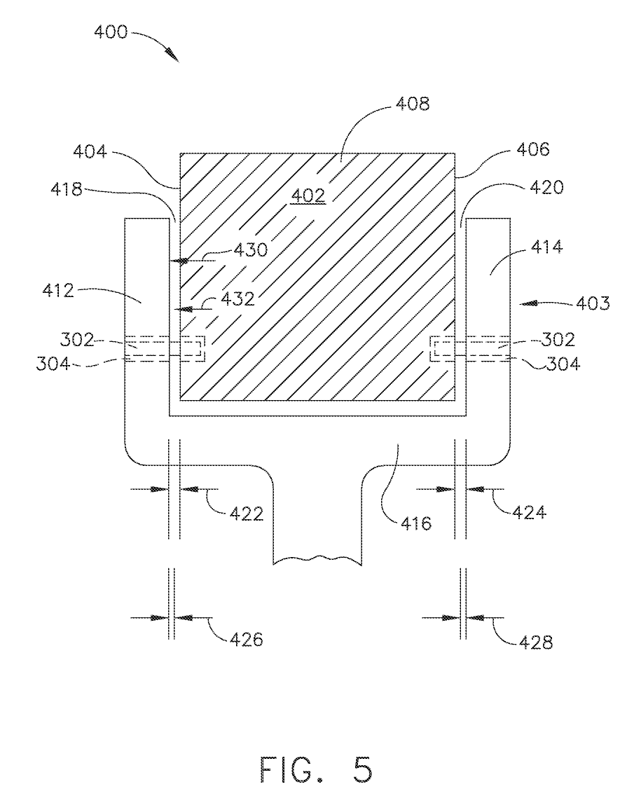

FIG. 5 is a side elevation view of a mechanical connecting joint 400 in accordance with an example embodiment of the present disclosure. In one embodiment mechanical connecting joint 400 is configured to join a first joint member 402, such as, but, not limited to vane hanger 216 to a second joint member 403. First joint member 402 is formed of a material having a first coefficient of thermal expansion (CTE) value, for example, a metal or metallic material, First joint member 402 includes a first sidewall 404, a second opposite sidewall 406, and a body 408 extending therebetween. Second joint member 403, such as, but, not limited to shank 214, is formed of a ceramic matrix composite (CMC) material having a second CTE value, the second CTE being less than the first CTE. Second joint member 403 is formed of a includes a first leg 412 facing first sidewall 404, a second leg 414 facing second sidewall 406, and a connecting member 416 extending between first leg 412 and second leg 414. A first gap 418 is defined between first joint member 402 and first leg 412. A second gap 420 is defined between first joint member 402 and second leg 414.

First gap 418 defines a first distance 422 between first joint member 402 and first leg 412 at a first temperature and a second distance 426 between first joint member 402 and first leg 412 at a second temperature, second distance 426 being different than first distance 422 and the second temperature being different than the first temperature. In the example embodiment, a change in distance between second distance 426 and first distance 422 is inversely related to a change in temperature between the second temperature and the first temperature. First joint member 402 exerts a first force 430 against first leg 402 at the first temperature and exerts a second force 432 against first leg 412 at the second temperature wherein second force 432 is greater than first force 430 and the second temperature is greater than the first temperature.

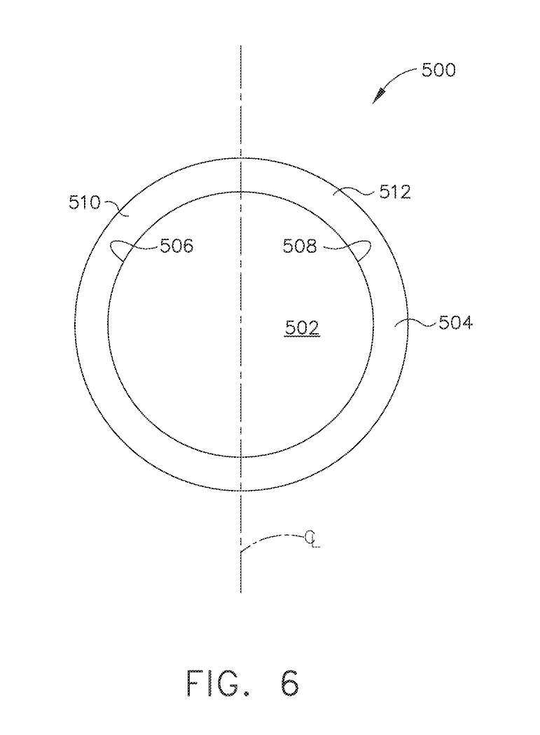

FIG. 6 is a plan view of a mechanical connecting joint 500 in accordance with another example embodiment of the present disclosure. In one embodiment mechanical connecting joint 500 is configured to join a first joint member 502 to a second joint member 504. In the example embodiment, a first sidewall 506 and a second opposite sidewall 508 are arcuately shaped and together form a circular cross-section. A first leg 510 and a second leg 512 are arcuately shaped and together form a circular cross-section complementary to first sidewall 506 and second sidewall 508. In various embodiments, mechanical connecting joint 500 is not circular, but rather may have other arcuate or square cross-sections, including, but not limited to, oval, oblong, elliptical, and the like.

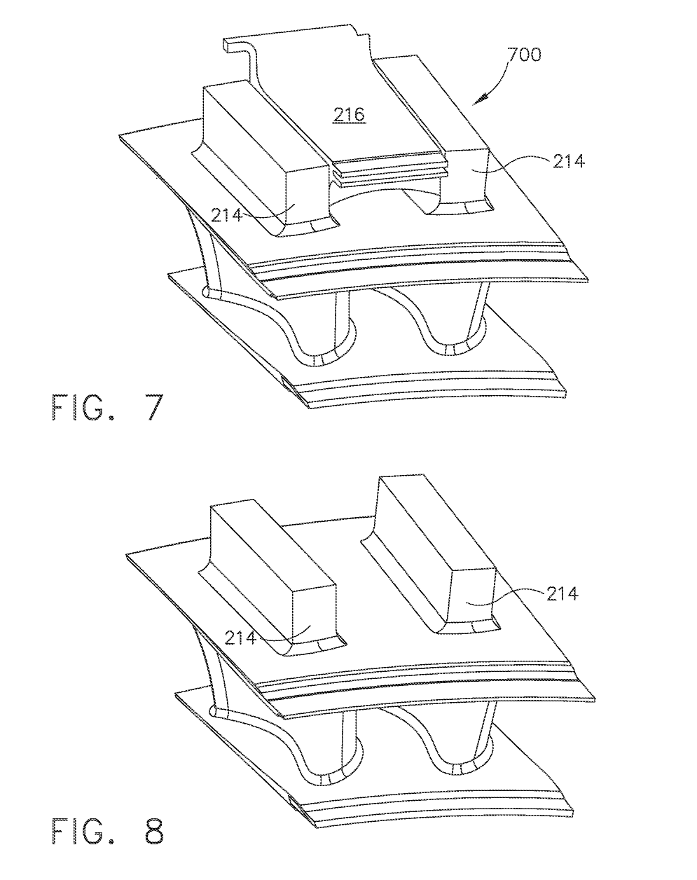

FIG. 7 is a perspective view of a cantilevered solid doublet CMC vane 700 including vane hanger 216, shank 214 and a metal mid seal 702. FIG. 8 is a perspective view cantilevered solid doublet CMC vane 700 showing only the CMC parts.

The above-described embodiments of an apparatus and system of joining components provide a cost-effective and reliable means for providing a rigid determinate attachment through relatively simple geometry and materials. More specifically, the apparatus and systems described herein facilitate the use of proven turbine attachment and assembly methods, which facilitates conventional sealing methods as well. As a result, the apparatus and systems described herein facilitate maintenance and assembly of components that operate in high temperature environments in a cost-effective and reliable manner.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mechanical connecting joint comprising:
a first joint member formed of a material having a first coefficient of thermal expansion (CTE) value, the first joint member comprising a first sidewall, a second opposite sidewall, and a body extending therebetween;
a second joint member formed of a material having a second CTE value, the second CTE being less than the first CTE, said second joint member comprising:
a first leg facing the first sidewall;
a second leg facing the second sidewall; and
a connecting member extending between said first leg and said second leg.

2. The mechanical connecting joint of claim 1, further comprising:
a first gap between said first joint member and said first leg; and
a second gap between said first joint member and said second leg.

3. The mechanical connecting joint of claim 2, wherein the first gap defines a first distance between said first joint member and said first leg at a first temperature and the first gap defines a second distance between said first joint member and said first leg at a second temperature, the second distance being different than the first distance and the second temperature being different than the first temperature.

4. The mechanical connecting joint of claim 2, wherein a change in distance between the second distance and the first distance is inversely related to a change in temperature between the second temperature and the first temperature.

5. The mechanical connecting joint of claim 1, wherein said first joint member exerts a first force against said first leg at a first temperature, said first joint member exerts a second force against said first leg at a second temperature wherein the second force is greater than the first force and the second temperature is greater than the first temperature.

6. The mechanical connecting joint of claim 1, further comprising a locating pin extending from within said first joint member into said second joint member.

7. The mechanical connecting joint of claim 1, wherein said first sidewall and said second opposite sidewall are arcuately shaped and together form a circular cross-section, said first leg and said second leg are arcuately shaped and together form a circular cross-section complementary to said first sidewall and said second sidewall.

8. The mechanical connecting joint of claim 1, wherein said first sidewall and said second opposite sidewall are arcuately shaped, said first leg and said second leg are arcuately shaped complementary to said first sidewall and said second sidewall.

9. The mechanical connecting joint of claim 1, wherein said first joint member comprises a metallic material.

10. The mechanical connecting joint of claim 1, wherein said second joint member comprises a ceramic material.

11. The mechanical connecting joint of claim 1, wherein said second joint member comprises a ceramic matrix composite (CMC) material.

12. A vane attachment assembly comprising:
a plurality of airfoil vane shanks extending from a vane platform, each of the airfoil shanks comprising a ceramic matrix composite material (CMC) having a first coefficient of thermal expansion (CTE); and
a vane hanger formed of a metal material having a second CTE, the airfoil hanger positioned between adjacent ones of the plurality of airfoil vane shanks, a surface of the airfoil hanger configured to expand outwardly with an increasing temperature towards the adjacent ones of the plurality of airfoil vane shanks thereby exerting a force into the adjacent ones of the plurality of airfoil vane shanks.

13. The airfoil attachment assembly of claim 12, further comprising a first bore extending from a surface of the airfoil hanger into the airfoil hanger and a second bore extending from a surface of one of the adjacent ones of the plurality of airfoil vane shanks into the vane shank and aligned with said first bore.

14. The airfoil attachment assembly of claim 13, further comprising a pin extending from within said first bore into said second bore.

15. The airfoil attachment assembly of claim 13, wherein said first bore and said second bore is sized such that a predetermined fit is achieved at operating temperature.

16. The airfoil attachment assembly of claim 13, wherein said plurality of airfoil vane shanks and said airfoil hanger are joined in a press fit between a surface of said plurality of airfoil vane shanks and a surface of said airfoil hanger.

17. The airfoil attachment assembly of claim 12, further comprising a gap between one of said plurality of airfoil vane shanks and said airfoil hanger, said gap configured to decrease in size when a temperature of said airfoil attachment assembly is increased from a first temperature to a second higher temperature.

18. A gas turbine engine assembly comprising:
a rotatable member comprising an axis of rotation and supported within a casing by a plurality of bearings;
a vane hanger comprising a metal material having a first coefficient of thermal expansion (CTE) positioned radially outward from said rotatable member within said casing, said airfoil hanger comprising a radially outer portion fixedly coupled to said casing and a radially inner portion comprising a vane attachment; and
a vane comprising a radially outer shank portion comprising a first leg and a second leg, each of said first and second legs extending radially outwardly on opposite sides of said airfoil attachment, each of said first and second legs comprising a ceramic matrix composite (CMC) material having a second CTE.

19. The gas turbine engine assembly of claim 18, further comprising a gap between said radially outer shank portion and said airfoil hanger, said gap configured to decrease in size when a temperature of said airfoil hanger is increased from a first temperature to a second higher temperature.

20. The gas turbine engine assembly of claim 18, further comprising a pin extending between said airfoil hanger and said radially outer shank.
